(19) United States
(12) Patent Application Publication
(10) Pub. No.: US 2009/0219390 A1
(43) Pub. Date: Sep. 3, 2009

(54) High Throughput Security Screening System for Transportation Applications

(75) Inventors: Regina Elvira Dugan, Rockville, MD (US); Khaled F. Eltomi, Orlando, FL (US); Thomas Emory McVeigh, Shenandoah Junction, WV (US); Jack Kotowicz, Washington, DC (US)

Correspondence Address: DIEDERIKS & WHITELAW, PLC, 12471 DILLINGHAM SQUARE, #301, WOODBRIDGE, VA, 22192, US

(73) Assignee: REDXDEFENSE, LLC, Rockville, MD (US)

(21) Appl. No.: 12/160,128

(22) PCT Filed: Jan. 8, 2007
(86) PCT No.: PCT/US07/00474

§ 371 Date: Feb. 23, 2009

Related U.S. Application Data
(60) Provisional application No. 60/756,574, filed on Jan. 6, 2006.

(51) Int. Cl. H04N 7/18; G08B 21/00; G06K 9/00

(52) U.S. Cl. 348/143; 340/540; 348/E07.085; 382/100

(57) ABSTRACT

A high throughput security screening system employed at access points of a transportation system includes a control portion, an ID portion and a screening portion. The screening portion includes a main housing, an input port provided in the main housing for receiving exhibits, sampling media positioned in the main housing that obtains a trace sample from the exhibits and a processing system for scanning the trace sample for a threat indicator. The screening system also includes a memory for storing information related to threat indicators for later processing. The memory also stores image data, time data and date data relating to each trace sample. With this arrangement, the screening system is capable of processing a high volume of exhibits while mitigating passenger inconvenience or wait times while still maintaining a high level of security.

### CROSS-REFERENCE TO RELATED APPLICATIONS

The present application claims the benefit of U.S. Provisional Patent Application Ser. No. 60/756,574, filed Jan. 6, 2006.

### BACKGROUND OF THE INVENTION

1. Field of the Invention

The present invention pertains to the art of security screening systems and, more particularly, to a high throughput security screening system employed at ground transportation access points.

2. Discussion of the Prior Art

Since Sep. 11, 2001, protection against terrorist threats has become a national priority. At present, most systems are heavily focused on aviation security. However, more recent attacks, such as the Madrid train station bombings on Mar. 11, 2004 and the London subway bombings on Jul. 7, 2005, have focused greater attention on the vulnerability of ground transportation systems. Various types of threats have been postulated, including attacks using explosives, chemical and biological agents, as well as nuclear and radiological agents (dirty bombs). The diversity of this threat has created complex security challenges. As a result, total expenditures related to Homeland Security topped $100 B in 2003 and billions more have been allocated in Federal, Supplemental Appropriations and State/Local spending. Accordingly, growth in the homeland security industry is expected to be vigorous over the next decade. Motivated by the wide diversity of potential threats, and by the inadequacy of currently available systems, government investments in research and development are stronger than ever. In addition, recent increases in funding for ground transportation security systems have highlighted the desire to improve protection, especially against explosive threats, in these facilities.

Of the various threats postulated, explosives remain the number one choice of most terrorists. Indeed, many experts have noted that in the case of terrorist activity, statistical evidence strongly indicates that the primary threat is explosives, i.e., bombs. Historical evidence suggests that even moderately effective portal screening, used to screen 100% (or nearly 100%) of personnel, increases the operational risk to would-be attackers and therefore poses a significant deterrent. Unfortunately, screening 100% of all passengers in, for example a public ground transportation hub, would create a significant throughput challenge. Given the large number if individuals who travel by public transportation on daily basis, presently available screening systems would create long queues or delays that would create an economic burden and impede commerce.

In the case of explosive screening, current systems can cost more than $1 M per portal for bulk explosives detection systems and tens of thousands of dollars for trace explosives detection systems. In addition, installation and annual maintenance costs often exceed the systems' purchase price. Some newer bulk detection systems, such as millimeter wave systems, have been proposed for high-throughput applications. However, millimeter wave systems suffer from significant signal processing and automatic target recognition demands as the systems are not specific to explosives. In addition, system responses from threat objects are highly dependent on a number of variables such as the object's position relative to the sensors, and other factors that are not easily controlled. In the case of trace explosives, currently deployed detection systems were developed primarily for the use of analytical chemists in laboratories and only later adapted for use in the field. Thus, currently available trace explosive detection systems suffer from very long clearance times after positive detections (15-30 minutes), have exceedingly high false alarm rates, and require extensive training to ensure proper use and maintenance.

Conventional explosive detection systems, developed primarily within constraints imposed by aviation security, are not suitable for ground transportation screening applications. Conventional systems are large, operator intensive, represent high capital and maintenance costs, do not have sufficiently high throughput, and suffer high false alarm rates. As such, they can most suitably be implemented in facilities or industries where significant choke points exist due to other operational constraints. However, as conventional systems demand dedicated processes, procedures, operators, and/or facilities for operation, they are not amenable to incorporation in other, highly distributed systems such as the thousands of turnstiles or entry points for ground transportation systems.

Conventional systems are also not suited for detecting trace amounts of explosives that may be found on passengers. Explosive contamination can vary widely over small spatial distances. Evidence shows that trace residue levels can differ by 10,000 fold over distances as short as a few centimeters. Unfortunately, currently available trace explosive detection systems are limited in their ability to obtain proper samples. More specifically, currently available systems only sample from limited spatial areas, with swipes of these areas being provided to a fixed base system. Obtaining samples from secondary surfaces such as tickets, credit cards, Driver's licenses, passports, or the like in conventional trace detection systems is known in the art. However, these systems require that a sample be collected from the secondary source using a swab or swiping technique. This swab or swipe then undergoes a thermal desorption step which is time intensive and which also necessarily restricts the amount of area that is interrogated for analysis.

Attempts to automate the swiping process involve the use of dedicated equipment that is not suitable for integration with existing ground transportation equipment. Furthermore, conventional systems do not incorporate a complete architecture that permits time-phased analysis of a sample to “buffer” high throughput demands, nor do existing systems provide a means to correlate the sample results with secondary information sources such as time, date, location, photo, video data and the like. As stated above, existing systems do not lend themselves to incorporation in existing ground transportation systems, such as fare collection systems, stand alone information booths such as fare card purchase systems, or other collection systems.

In summary, currently available conventional screening systems suffer from many disadvantages that have been described previously, including high cost, low throughput, high false alarm rates, operational complexity, high maintenance and training requirements, poor sample recovery, lack of spatial information on the sample recovered, and the like. These limitations have created a significant barrier to the use of existing systems in ground transportation applications.

Based on the above, despite the existence of security screening systems in the art, there still exists a need for a security screening system that can be incorporated into existing ground transportation systems. More specifically, there exists a need for a security screening system that enables a high throughput in order to reduce passenger wait times yet still ensures thorough screening for all passengers.

### SUMMARY OF THE INVENTION

The present invention is directed to a high throughput security screening system employed at access points of a ground transportation system. The screening system includes a main housing having an input port provided for receiving exhibits such as fare cards, a sampling media positioned in the main housing that obtains a trace sample from the exhibits and a processing system for scanning the trace sample for a threat indicator. In accordance with the invention, the screening system also includes a memory for storing or buffering information related to threat indicators. With this arrangement, the screening system is capable of processing a high volume of exhibits while maintaining a high level of security and mitigating passenger inconvenience or wait times.

In further accordance with the invention, during periods of high volume processing, such as rush hour or the like, the screening system buffers trace samples for later processing. The trace samples are correlated to information obtained from passengers passing through the screening system. Thus, in the event that a particular trace sample tests positive for a threat indicator, security personnel are provided with information about the passenger(s) that tested positive. For example, security personnel are provided with various pieces of information, such as time/date of use of the exhibit, video and/or still photographs, audio signals and the like, which can aid in the apprehension and possible detention of the passenger. The screening system also employs various algorithms that allow security personnel to rapidly address false alarms so as to further ensure minimal disruption of passenger flow.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of an entrance to a ground transportation system employing a security screening system constructed in accordance with the present invention;

FIG. 2A is an example of an exhibit shown in the form of a fare card employed in connection with the ground transportation system of FIG. 1;

FIG. 2B is an example of an exhibit shown in the form of a plurality of tokens employed in connection with the ground transportation system of FIG. 1;

FIG. 2C is an example of an exhibit shown in the form of paper currency employed in connection with the ground transportation system of FIG. 1;

FIG. 2D is an example of an exhibit shown in the form of a smart/credit card employed in connection with the ground transportation system of FIG. 1;

FIG. 3 is a top, cut-away view of an access barrier having a sample collection device employed in connection with the security screening system of FIG. 1;

FIG. 4 is a flow chart illustrating operation of the security screening system of FIG. 1;

FIG. 5 is a graph illustrating a data capture and recording portion of the security screening system;

FIG. 6 is an example of a snap shot of a computer screen showing a regional overview of the ground transportation system associated with the security screening system;

FIG. 7 is an example of a snap shot of a computer screen showing a local overview of the ground transportation system associated with the security screening system; and

FIG. 8 is an example of a snap shot of a computer screen showing a security event occurring at a station of the ground transportation system associated with the security screening system.

### DETAILED DESCRIPTION OF THE PREFERRED EMBODIMENT

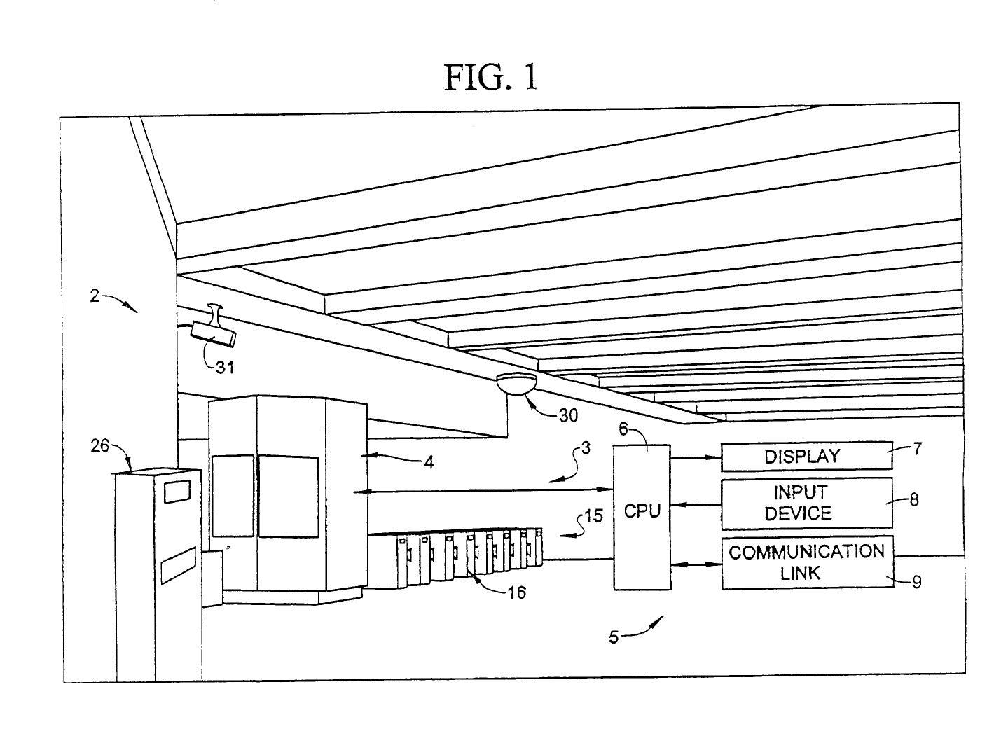

With initial reference to FIG. 1, a high throughput security screening system 2 constructed in accordance with the present invention is shown employed in connection with a ground transportation system (not shown) that is accessed through, for example, a subway entrance 3. As shown, arranged at subway entrance 3 is an information/security booth 4 within which is housed a local control portion 5 of security screening system 2. Local control portion 5 includes a central controller or CPU 6 that is linked to a display 7 and an input device 8. Local control portion 5 is also shown with a communication link 9. As will be discussed more fully below, an operator sitting in information booth 4 can set a threat level for security screening system 2 through input device 8 or, alternatively, security screening system 2 can be updated remotely through communication link 9.

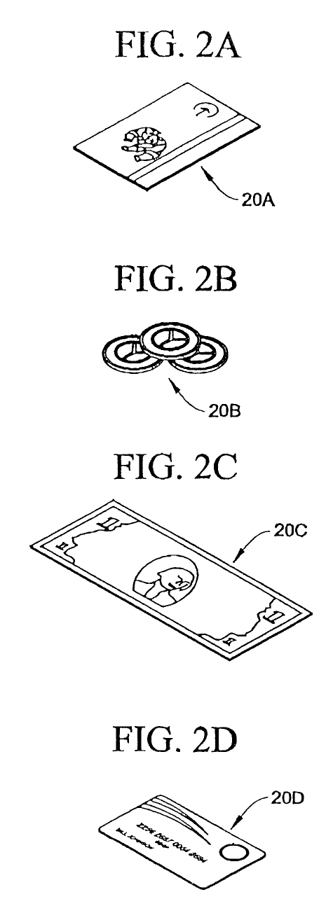

In accordance with the invention, security screening system 2 also includes a screening portion 15 which takes the form of a plurality of access barriers or turnstiles, one of which is indicated at 16. Although screening portion 15 is shown at access barrier 16, it could also be separated therefrom. In any case, in order to gain access to ground transportation through subway entrance 3, a user must first insert an exhibit, such as shown at 20A-20D in FIGS. 2A through 2D into access barrier 16. More specifically, a user or passenger will either already have or will purchase an exhibit from a kiosk or vending machine 26. In accordance with the invention, the exhibit can take a wide range of forms, including a fare card 20A such as shown in FIG. 2A, tokens 20B as shown FIG. 2B, a currency note 20C as shown in FIG. 2C, a credit or smart card 20D as shown in FIG. 2D, or the like. As will be discussed more fully below, access barrier 16 scans the exhibit for various threat indicators in order to determine whether a particular passenger poses a potential threat to, for example, the ground transportation system. In addition to scanning passengers at access barrier 16, security screening system 2 includes an ID portion 29 including multiple imaging devices shown in the form of cameras 30 and 31 which are slaved or cued to security screening system 2 and selectively activated to capture still and/or video images of a passenger or passengers associated with each exhibit being inserted for scanning. Although not shown, ID portion 29 also captures audio signals from select ones of the passengers passing through entrance 3.

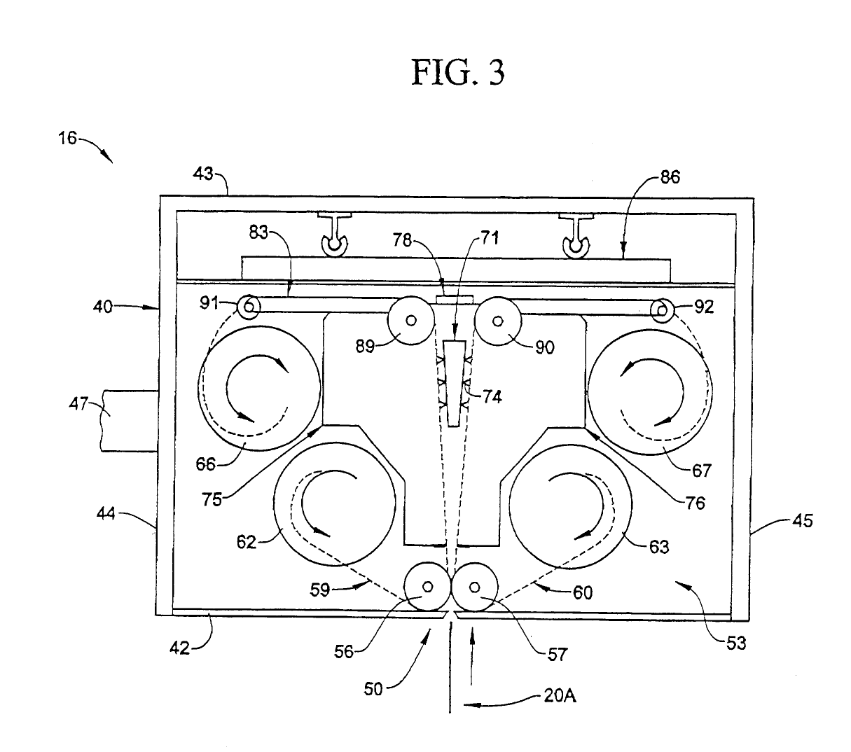

As shown in FIG. 3, each access barrier 16 includes a main housing 40 having front, rear and opposing side walls 42-45. A retractable barrier 47 projects outwardly from side wall 44. Retractable barrier 47 shifts into main housing 40 in order to allow a passenger to pass through subway entrance 3 after an appropriate exhibit has been inserted into an input port 50 arranged on front wall 42. As will be detailed more fully below, not only does inserting the exhibit into input port 50 enable the passenger to gain access to the ground transportation system, but access point 16 also performs a security screening of the exhibit. More specifically, arranged within main housing 40 is a screening system 53 that obtains and analyzes a trace sample from the exhibit as will be discussed more fully below.

In accordance with the invention, screening system 53 includes a pair of friction rollers 56 and 57 that guide exhibit, for example exhibit 20a, into contact with sampling media. More specifically, exhibit 20a is guided between, and brought into contact with, first and second sheets of sampling media sheets 59 and 60 to obtain a trace sample. Typically, once the trace sample is collected, the exhibit is returned to the passenger. Sampling media sheets 59 and 60 are preferably treated with an adhesive, pre-impregnated catalysts and/or other pre-treatment medium. Unused portions of sampling media sheets 59 and 60 reside on respective ones of new media spools or rolls 62 and 63, with used portions of media sheets 59 and 60 being retained on corresponding ones used media spools or rolls 66 and 67. Screening system 53 could also include additional spools/rolls (not shown) to store used sampling media for later analysis during times of high passenger volume. As will be discussed more fully below, after contacting exhibit 20a, the sampling media sheets 59 and 60 are passed by an applicator 71. Applicator 71 deposits a chemical reagent onto a portion of sampling media sheets 59 and 60 prior to processing. More specifically, applicator 71 directs a reagent 74 on the portion of sampling media sheets 59 and 60 that contracted the exhibit. In any event, as shown, applicator 71 is separated from new media rolls 62 and 63 and used media rolls 67 and 68 by respective shields 75 and 76. Shields 75 and 76 prevent any debris or reagent 74 from inadvertently contacting sampling media sheets 59 and 60 and potentially causing contamination that may corrupt the trace sample.

In addition to applicator 71, screening system 53 includes a secondary processing unit 78 which add overall controls in connection with accepting exhibit 20a, rotating rollers 62, 63, 66 and 67, injecting reagent 74 and performing the threat residue analysis. Screening system 53 further includes an imaging bed 83 and an image scanner 86. Image scanner 86 is preferably in the form of an optical explosive detection sensor which unobtrusively measures explosive contamination from a secondary source, e.g., sampling media sheets 59 and 60. For example, screening system 53 could employ spatially resolved detection that utilizes photoluminescent polymers/copolymers or other color change, luminescent or fluorescent techniques to detect threat residue. Finally, screening system 53 is shown to include a number of rollers/guides 89-92 which ensure that sampling media sheets 59 and 60 are properly guided from new media rolls 62 and 63 to used media rolls 66 and 67.

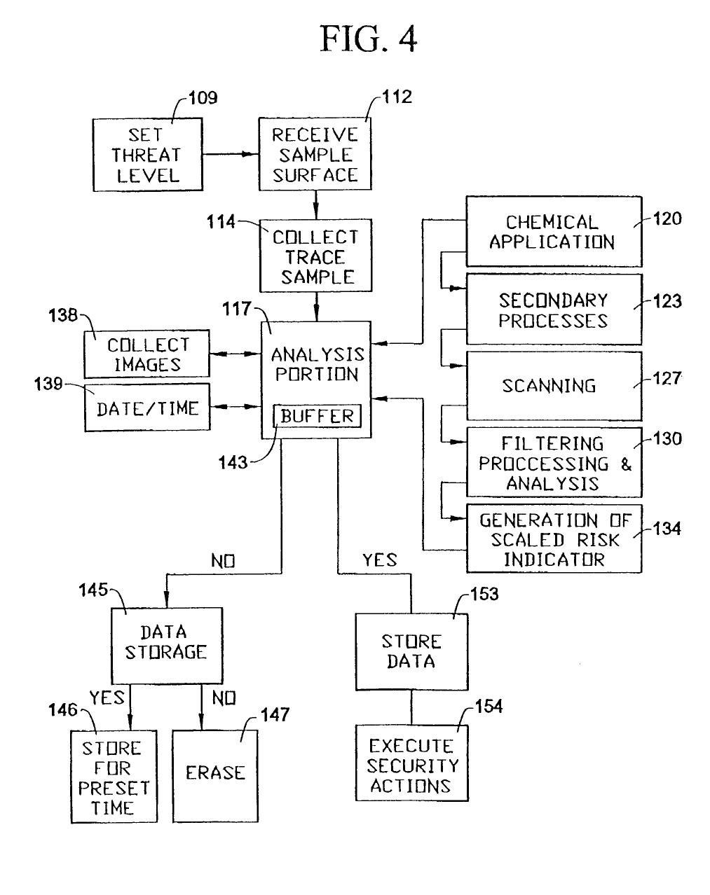

Reference will now be made to FIG. 4 in describing a preferred method of operation of security and screening system 2. As noted above, a threat level is initially established for screening system 2 at information booth 4 or, remotely through communication link 9. As shown in step 109, the threat level preferably establishes a sensitivity level for screening system 2. More specifically, during a low threat level, screening system 2 will employ a low detection threshold in order to provide a high throughput rate. However, during a high threat level, screening system 2 will set a high screening threshold or increased sensitivity in order to increase the likelihood of detecting any and all potential threats passing through entrance 2. Setting a higher screening threshold decreases throughput times and increases screening time. However, as will be discussed more fully below, screening system 2 includes various systems to mitigate a loss of throughput due to increased sensitivity. In any event, screening system 2 initially receives an exhibit 20a having a sample surface in step 112. Upon receipt of an exhibit, a trace sample is collected in step 114. More specifically, sample media sheets 59 and 60 are brought into contact with the exhibit to obtain a trace sample. The trace sample is then analyzed in step 117.

During analysis, chemicals (reagent 74) are applied to the trace sample in step 120, and secondary processes, such as heated drying, are optionally conducted in step 123 before the trace sample is scanned in step 127 to obtain a scanned image of the trace sample. Reference can be made to co-pending U.S. patent application Ser. No. 11/525,344 entitled “System and Method For Optimization of Trace Chemical Sample Collection and Analysis in Personnel Screening and Security Systems” filed on Sep. 22, 2006, which is incorporated herein by reference, for a detailed explanation of one preferred form of threat analysis system. However, in short, the scanned image of the trace sample is then subjected to a filtering, processing and analysis step 130 which generates a scaled risk indicator in step 134. Processing of the scanned image can include serial and/or parallel processing depending upon a particular designed sensitivity level and throughput. The scaled risk indicator is employed to determine whether the trace sample contains a threat residue.

At this point, it should be noted that analysis portion 117, depending upon the established threat level and, optionally, time of day, e.g. rush hour, will collect images from ID portion 29 in step 135 and establish a date/time stamp for each trace sample in step 139. More specifically, during rush hour and other high volume times, an image and date/time stamp is collected for each exhibit passing into screening system 53. The scaled risk indicator obtained in step 134, the image obtained in step 138 and date/time stamp collected in step 139 are stored in a memory or buffer 143 for later evaluation. With this arrangement, screening system 2 can ensure a high throughput even during times of high passenger volume and high sensitivity. After the high passenger volume has subsided, buffer 143 is evaluated for any potential threat indicators. Any trace samples containing a threat indicator are correlated with a particular exhibit, image and date/time stamp and passed on for further security actions. Alternatively, during times of high passenger volume, sample media could be stored on a buffer roll (not shown) for subsequent forensic evaluation when processing demands are lower. During all other times, analysis portion 117 provides real time analysis on the trace samples.

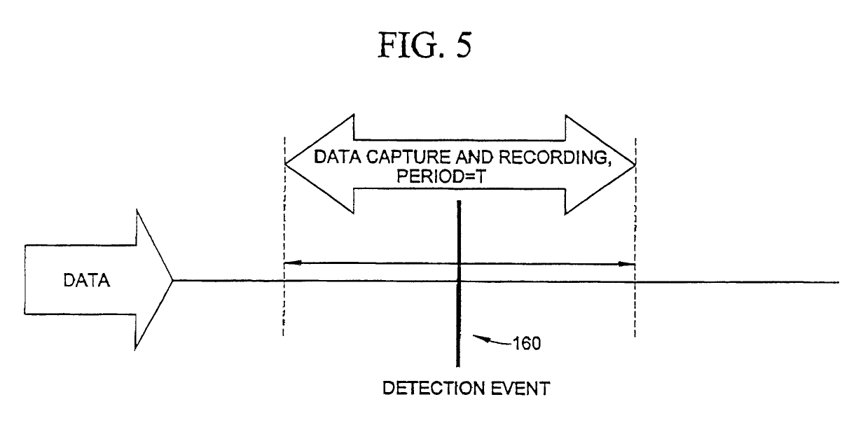

If analysis portion 117 reveals no threat indicator on the trace sample, information is passed to a data storage step 145. If a data storage flag is set high, information is stored for a preset time period in step 146. That is, the information is preferably passed onto a data storage device (not shown) and stored for a predetermined time period. If the data storage flag is set low, the information is simply erased at 147. Conversely, if analysis portion 117 signals a detection event 160, i.e., determines the presence of a threat indicator, data associated with the detection event is stored in step 153, an alarm is set and security actions are executed in step 154. More specifically, as best shown in FIG. 5, in the event detection system 53 identifies a detection event 160, data capture and video is saved for a time period T. Time period T represents a period of time before and after the detected event. In this manner, security personnel are provided with additional help in determining who and what may have triggered security system 2. By only storing the data related to a sensed, potential threat, storage requirements are minimized. However, if a positive threat detection is made, the invention advantageously provides for the storage of data from both before and after the screening process.

At this point, it should be recognized that, by providing controls at information booth 4, any alarms can readily be resolved without triggering a full blown security response. That is, in the event that an alarm is signaled, a security person or operator located in information booth 4 can resolve any false alarms by real-time examination of a ticket to verify the result, re-scan a particular individual and/or take remedial measures in order to mitigate the need for a significant security response which would disrupt passenger flow.

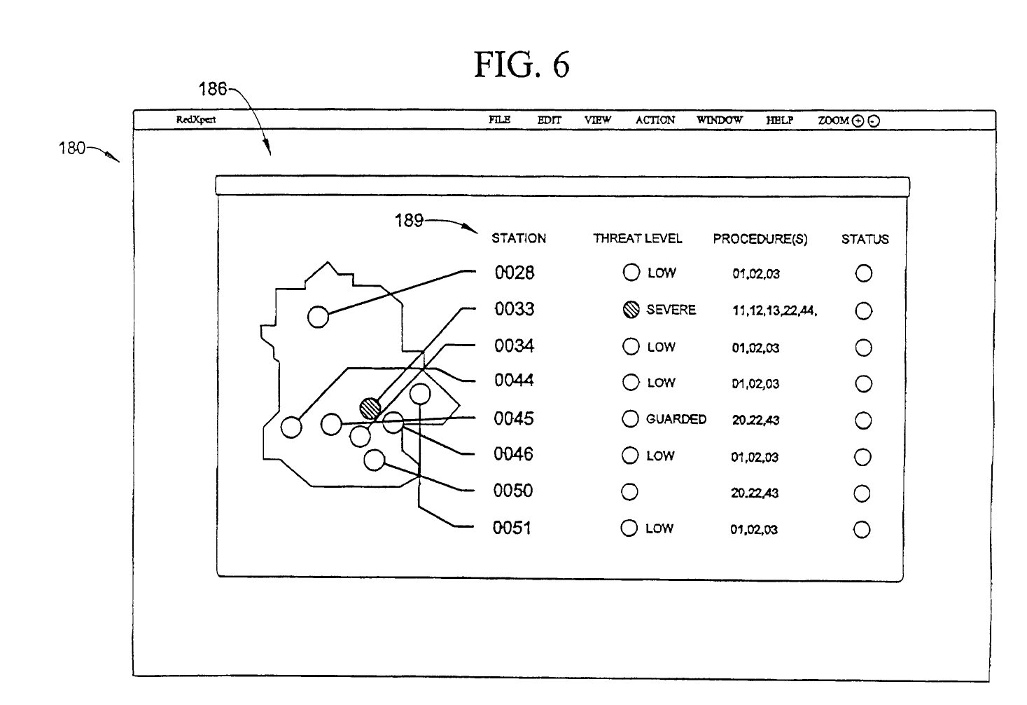

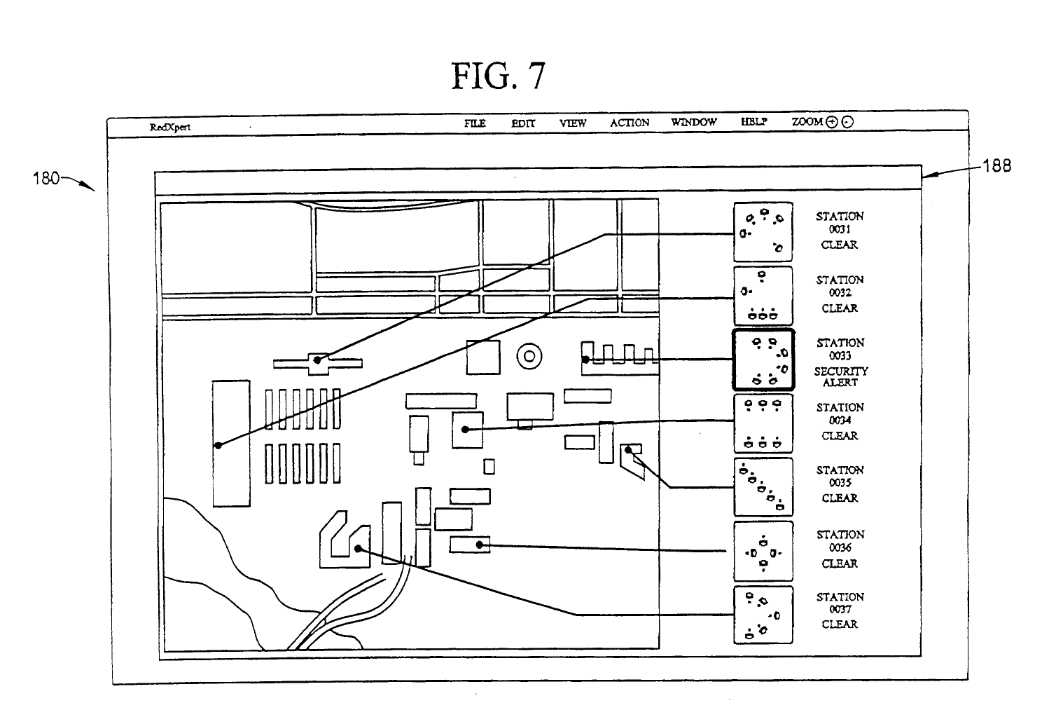

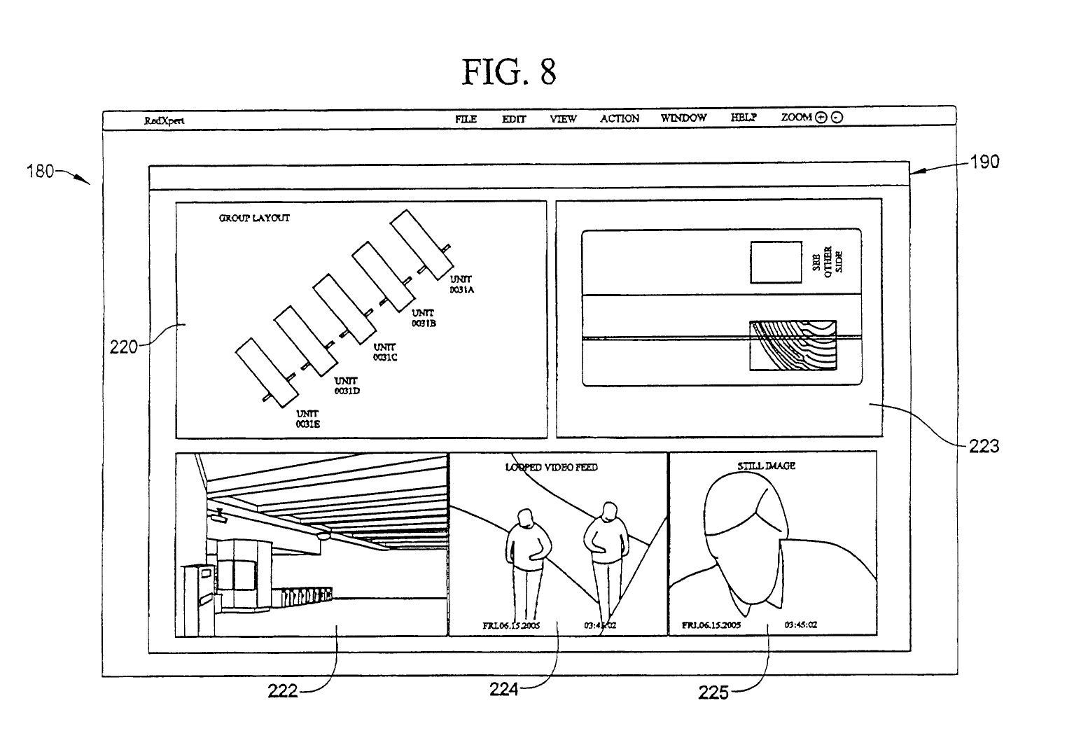

In further accordance with the present invention, in addition to providing localized monitoring at, for example, entrance 3, security screening system 2 also includes a central control portion 180 that monitors the ground transportation system on various levels such as depicted in FIGS. 6-8. More specifically, information obtained from each subway entrance 3 is passed, via communication link 9, to a main control center (not shown). At the main control center, operators can monitor various computer displays which show various stations at a regional level such as shown at 186 in FIG. 6, a local level such as shown at 188 in FIG. 7, and a station level such as shown at 190 in FIG. 8.

On the regional level, operators can monitor each station, threat level, current operating procedures and status for a particular region of the ground transportation system. In the event of an alert resulting in the setting of a severe threat level, such as shown at station 33, an operator can move to the local level 188 of FIG. 7 which provides an overview of the particular location of station 33 in a localized grid map. An operator can also zoom to the particular station 33 as shown at 190 in FIG. 8. That is, in the event that an alarm is triggered in, for example, station 33 an operator can shift to the particular station screen 190 which depicts the particular entrance at issue, both graphically as in screen 220 and via video as in screen 222. In addition, the operator can view an image of the exhibit in question in screen 223, as well as video and still images of the passenger associated with the exhibit in screens 224 and 225 respectively. This particular feature enables authorities to direct personnel to the particular station and/or individual that triggered the alarm.

Based on the above, screening for explosives and explosives-related compounds in ground transportation facilities is of particular interest; however, the system may incorporate multiple security sensor systems including chemical agent, biological agent, radiological substance, metal detection, biometric identification sensors, among others, for the purpose of identifying security risks. Screening may occur in private and/or public facilities such as train stations, metro stations, bus stations, commuter rail stations, or other like facilities, and may be used in regulated or unregulated environments. The system is a fully integrated hardware and software system that incorporates at least one security sensing system, preferably a trace explosive detection system, and a method for resolving alarms and/or storing additional correlated information for immediate security use or for later security, law enforcement or forensics purposes. This information may include time and date, location, video data, an image of the subject causing an alarm, audio signals, among other data. Notably, the purpose of this system is to provide a capability to identify threats early in their development by identifying high risk individuals and/or behaviors. The system provides a means of interaction that is unobtrusive, high throughput, dynamically adjustable based on threat level, and allows for ‘soft’ false alarm resolution to avoid detaining subjects unnecessarily. An important feature of this system is that the sample is provided by the subject rather than requiring the use of dedicated personnel to obtain a sample and further, that the sample can be obtained and analyzed quickly.

Although described with reference to a preferred embodiment of the invention, it should be readily understood that various changes and/or modifications can be made to the invention without departing from the spirit thereof. For instance, while described with respect to a ground transportation system such as a subway, the present invention could also be employed in connection with user access to various transportation systems, including trains, buses and the like. In addition, to capturing video feed of detecting the event, the security scanning system could also capture audio signals. Furthermore, while the system is described as obtaining a trace sample from an exhibit in the form of an object received from a passenger, exhibits having trace samples may also be obtained directly from passengers such as through fingerprints, thumbprints, etc. by a contact pad or the like which establishes the input port. In general, the invention is only intended to be limited by the scope of the following claims.

I/We claim:

1. A high throughput security screening system for monitoring access points of a ground transportation system which requires exhibits to be received by an access barrier prior to boarding a transport vehicle, said screening system comprising:
a main housing;
an input port provided in the main housing, said input port being adapted to receive an exhibit to be screened;
a sampling media positioned in the main housing, said sampling media being adapted to obtain a trace sample from the exhibit received by the input port;
a processing system for analyzing the trace sample for a threat indicator; and
a memory for storing information related to the threat indicator.

2. The high throughput security screening system according to claim 1, further comprising: an ID portion having at least one imaging device for capturing at least one of streaming images and still photographs.

3. The high throughput security screening system according to claim 2, wherein the at least one imaging device is in the form of a video camera.

4. The high throughput security screening system according to claim 2, wherein the at least one imaging device is in the form of a camera that captures still images.

5. The high throughput security screening system according to claim 1, wherein the information stored in the memory includes a time stamp and a date stamp, each of said time and date stamps being associated with a particular trace sample.

6. The high throughput security screening system according to claim 1, wherein the sampling media comprises multiple sheets which come into contact with opposing sides of the exhibit.

7. The high throughput security screening system according to claim 1, wherein the threat indicator is constituted by explosive residue.

8. The high throughput security screening system according to claim 1, wherein the exhibit is constituted by at least one of a fare card, credit card, monetary note and token.

9. The high throughput screening systems according to claim 1, wherein said memory buffers trace samples for later processing.

10. A method of screening passengers prior to boarding a ground transportation system comprising:
inserting an exhibit into an input port of an access barrier arranged at an entrance to the ground transportation system;
guiding the exhibit into contact with a sampling media to obtain a trace sample from the exhibit;
analyzing the trace sample for a threat indicator; and
storing information relating to the threat indicator.

11. The method of claim 13, further comprising: providing real time analysis of the trace sample.

12. The method of claim 10, further comprising: sending an indication that a threat indicator is found on an exhibit to a central control system.

13. The method of claim 10, further comprising: later analyzing the stored information.

14. The method of claim 10, wherein analyzing the trace sample for the threat indicator includes scanning the trace sample for an explosive residue.

15. The method of claim 10, further comprising: guiding the exhibit between two separate sampling media sheets so as to scan opposing sides of the exhibit for the threat indicator.

16. The method of claim 10, further comprising: capturing image data of an area adjacent the access barrier.

17. The method of claim 16, wherein capturing image data includes capturing video images of the area adjacent the access barrier.

18. The method of claim 16, wherein capturing image data includes capturing still images of the area adjacent the access barrier.

19. The method of claim 10, wherein inserting the exhibit includes inserting one of a fare card, token, monetary note and credit card into the input port.

20. The method of claim 10, wherein storing information relating to the threat indicator includes setting both time and date stamps for the trace sample.
